(19) United States
(12) Patent Application Publication
(10) Pub. No.: US 2021/0276496 A1
(43) Pub. Date: Sep. 9, 2021

(54) Detachable Vehicle Accessory Snap-In Strip And Method For Manufacturing The Same

(71) Applicant: NAJE FATTOUCHE, Bowie, MD (US)

(72) Inventor: NAJE FATTOUCHE, Bowie, MD (US)

(73) Assignee: NEO DESIGN, LLC, Bowie, MD (US)

(21) Appl. No.: 17/330,015

(22) Filed: May 25, 2021

(51) Int. Cl. B60R 13/00

(52) U.S. Cl. CPC B60R 13/00; B60R 13/005

(57) ABSTRACT

A detachable snap-in strip of the present invention 20a is comprised of an elongate panel 16a, comprising a rigid polymer upper longitudinal edge 31a upon which is manufactured and attached a major rigid polymer longitudinal curved upper lip 30a, a rigid polymer lower longitudinal edge 41a upon which is manufactured and attached a major rigid polymer longitudinal curved lower lip 40a, a rigid polymer right side longitudinal edge 51a upon which is manufactured and attached a minor rigid polymer longitudinal curved right lip 50a, and a rigid polymer left side longitudinal edge 61a upon which is manufactured and attached a minor rigid polymer longitudinal curved left lip 60a. The major rigid polymer longitudinal curved upper lip 30a, the major rigid polymer longitudinal curved lower lip 40a, the minor rigid polymer longitudinal curved right lip 50a, and the minor rigid polymer longitudinal curved left lip 60a are all manufactured and attached to their respective curved longitudinal edges at angles between 120 degrees and 180 degrees. Any deviation from the aforementioned specific ranges will prevent the proper installation of the detachable snap-in strip of the present invention. In addition, a three dimensional (3D) scanned imaging of the individual embodiment component parts is generated, after rigorous testing, and is transferred to an injection molding computer to generate the injection molding designed precisely corresponding to each individual component part of the present invention.

### TECHNICAL FIELD

The presently disclosed subject matter relates to a detachable vehicle accessory snap-in strip and, more particularly, to a detachable vehicle accessory snap-in strip affixed to various vehicle accessories for purposes such as identification, illumination and overall decoration, etc.

### BACKGROUND

Decorative assembly components for a manufacturer's vehicle accessory or for an after-market's vehicle accessory are components which can be added to a manufacturer's vehicle accessory or can be added to an after-market's vehicle accessory, so as to add decoration and customization to a vehicle beyond what is supplied by an original manufacturer's vehicle accessory or an original after-market's vehicle accessory. One such component is a vehicle's accessory strip, which may be affixed to a vehicle accessory, or may be affixed but yet detachable from a vehicle's accessory. A vehicle accessory strip is capable of bearing an emblem whether affixed within a manufacturer's vehicle accessory, or affixed within an after-market's vehicle accessory. Commonly, a vehicle accessory strip capable of bearing an emblem is typically custom manufactured to precisely fit within a vehicle's door handle or a vehicle's door handle cover, a vehicle's grille, a vehicle's wheel or a vehicle's wheel cover, a vehicle's mirror cover, and a vehicle's rotation assembly external cap, etc. That therefore, the vehicle accessory snap-in strip of the present invention is capable of bearing an emblem and at the same time is finished in a chrome or black finish, thus providing a new look to the vehicle installed thereon.

Prior to the invention of a vehicle accessory snap-in strip capable of bearing an emblem therein, vehicle accessories were decorated using one of the following three techniques: baked-enamel coating, adhesive paper and ornaments. Baked-enamel coating required painting the entire outer surface of an automobile accessory which turned out to be a very expensive proposition. Although cheaper, adhesive paper often left bubbles when attempts were made to smooth attached adhesive papers onto a vehicle. In addition, conventional ornaments were not changeable after being attached to a vehicle and thus lacked versatility.

### GENERAL DESCRIPTION

One objective of the present invention is to provide a detachable snap-in strip capable of bearing an emblem, and constructed of rigid material capable of being flexed and optionally constructed of a single piece of polymer material capable of affixing within a vehicle's accessory, such as a vehicle's door handle or door handle cover, a vehicle's grille, a vehicle's wheel or wheel cover, a vehicle's mirror cover, and a vehicle's rotation assembly external cap, etc.

Another objective of the present invention is to provide a detachable snap-in strip capable of bearing an emblem comprising a major rigid polymer curved upper lip and a major rigid polymer curved lower lip.

Still, another objective of the present invention is to provide a detachable snap-in strip capable of bearing an emblem comprising a minor rigid polymer curved right lip and a minor rigid polymer curved left lip.

Still, another objective of the present invention is to provide a detachable snap-in strip capable of bearing an emblem and adapted for engagement to a vehicle's accessory with an elongate panel comprising an upper longitudinal edge upon which is manufactured and attached a major rigid polymer longitudinal curved upper lip, a rigid polymer lower longitudinal edge upon which is manufactured and attached a major rigid polymer longitudinal curved lower lip, a right side longitudinal edge upon which is manufactured and attached a minor rigid polymer longitudinal curved right lip and a rigid polymer left side polymer longitudinal edge upon which is manufactured and attached a minor rigid polymer longitudinal curved left lip, wherein each said upper and lower curved lip is comprised of a curved hook-shaped member that defines an interior region adapted to grippingly engage a rear surface of a vehicle's accessory.

Yet, another objective of the present invention is to provide a detachable snap-in strip capable of bearing an emblem and comprising an elongate panel contoured to precisely conform to a visible frontal surface area opening of a vehicle accessory, wherein said elongate panel is forcefully slid beneath said vehicle's accessory frontal opening surface area when snap-in pressure is applied with the intent of having the major and minor curved lips of said elongate panel being flushed onto and against a rear surface portion of said vehicle's accessory opening frontal surface area.

Still yet, another objective of the present invention is to provide a detachable snap-in strip capable of bearing an emblem wherein the elongate panel may be composed of a rigid polymer material that can be temporarily flexed during installation of said detachable snap-in vehicle's accessory.

Still yet, another objective of the present invention is to provide a detachable snap-in strip capable of bearing an emblem wherein the elongate panel is manufactured from a rigid material that allows for manipulation of the elongate panel during installation into a vehicle accessory to facilitate engagement of the interior region of the major and the minor curved lips on the rear surface area portions of a vehicle's accessory frontal opening surface area.

Yet still, another objective of the present invention is to provide a detachable snap-in strip capable of bearing an emblem, wherein the frontal surface area of said snap-in strip is finished with a decorative finish and furnished with LED lights.

Among advantages of certain embodiments of the presently disclosed subject matter is that the detachable snap-in strip capable of bearing an emblem can be snapped into a vehicle's accessory using the interior region of its major and minor curved lips, without requiring the use of double-sided tape or clips to hold the detachable snap-in strip in place.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A illustrates a frontal perspective view of a snap-in detachable vehicle accessory strip bearing an emblem prior to installation within a vehicle's accessory, such as the Chevrolet Bowtie in accordance with an embodiment of the presently disclosed subject matter;

FIG. 1B illustrates a frontal perspective view of a snap-in detachable vehicle accessory strip after installation within a vehicle's accessory, such as the Chevrolet Bowtie in accordance with an embodiment of the presently disclosed subject matter;

FIG. 1C illustrates a rear perspective view of a snap-in detachable vehicle accessory strip after installation within a vehicle's accessory, such as the Chevrolet Bowtie in accordance with an embodiment of the presently disclosed subject matter;

FIG. 1D illustrates a cross-sectional view of a snap-in detachable vehicle accessory strip prior to installation within a vehicle's accessory, such as the Chevrolet Bowtie in accordance with an embodiment of the presently disclosed subject matter;

FIG. 1E illustrates a cross-sectional view of a snap-in detachable vehicle accessory strip after installation within a vehicle's accessory, such as the Chevrolet Bowtie in accordance with an embodiment of the presently disclosed subject matter;

FIG. 2A illustrates a frontal perspective view of a snap-in detachable vehicle accessory strip prior to installation within a vehicle's mirror cover, in accordance with an embodiment of the presently disclosed subject matter;

FIG. 2B illustrates a frontal perspective view of a snap-in detachable vehicle accessory strip after installation within a vehicle's mirror cover, in accordance with an embodiment of the presently disclosed subject matter;

FIG. 2C illustrates a rear perspective view of a snap-in detachable vehicle accessory strip after installation within a vehicle's mirror cover, in accordance with an embodiment of the presently disclosed subject matter;

FIG. 2D illustrates a cross-sectional view of a snap-in detachable vehicle accessory strip after installation within a vehicle's mirror cover in accordance with an embodiment of the presently disclosed subject matter;

FIG. 3A illustrates a frontal perspective view of a snap-in detachable vehicle accessory strip prior to installation within a vehicle's door handle cover, in accordance with an embodiment of the presently disclosed subject matter;

FIG. 3B illustrates a frontal perspective view of a snap-in detachable vehicle accessory strip after installation within a vehicle's door handle cover, in accordance with an embodiment of the presently disclosed subject matter;

FIG. 3C illustrates a rear perspective view of a snap-in detachable vehicle accessory strip after installation within a vehicle's door handle cover, in accordance with an embodiment of the presently disclosed subject matter;

FIG. 3D illustrates a cross-sectional view of a snap-in detachable vehicle accessory strip after installation within a vehicle's door handle in accordance with an embodiment of the presently disclosed subject matter;

FIG. 4 illustrates a frontal perspective view of a snap-in detachable vehicle accessory strip after installation within a vehicle's wheel cover cap, in accordance with an embodiment of the presently disclosed subject matter;

FIG. 5 illustrates a frontal perspective view of a snap-in detachable vehicle accessory strip after installation within a vehicle's wheel cover overlay, in accordance with an embodiment of the presently disclosed subject matter;

FIG. 6 illustrates a frontal perspective view of a snap-in detachable vehicle accessory strip after installation within a vehicle's span-in grille overlay, in accordance with an embodiment of the presently disclosed subject matter;

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, and components have not been described in detail so as not to obscure the presently disclosed subject matter.

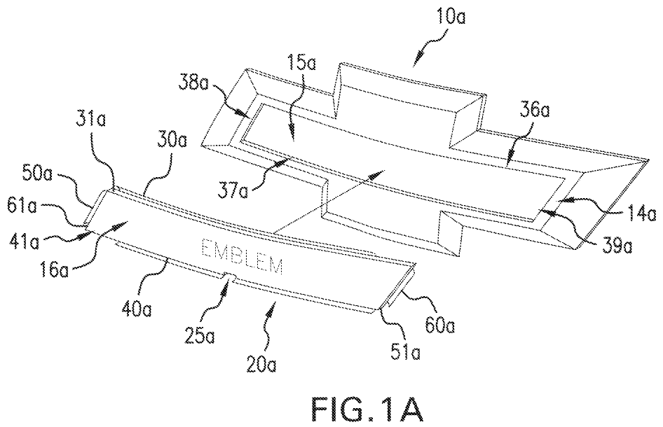

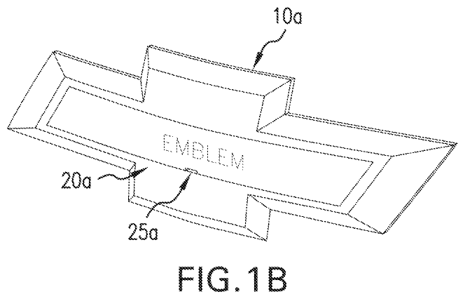

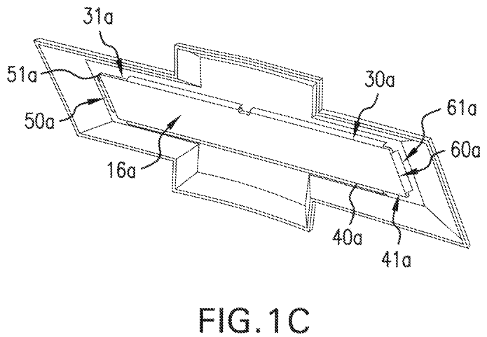

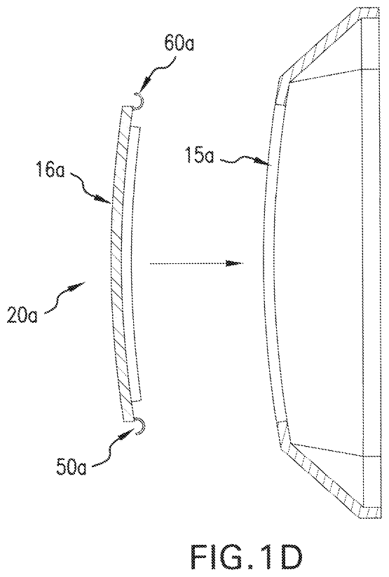

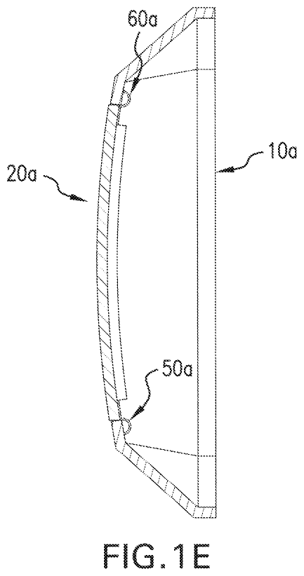

Bearing in mind, attention is drawn to FIGS. 1A, 1B, 1C, 1D and 1E, which illustrate a frontal perspective view of a detachable snap-in vehicle accessory strip prior to installation within a vehicle's accessory such as a Chevrolet Bowtie, a frontal perspective view of a snap-in detachable vehicle accessory strip after installation within a vehicle's accessory such as a Chevrolet Bowtie, a rear perspective view of a detachable snap-in vehicle accessory strip after installation within a vehicle's accessory such as a Chevrolet Bowtie, a cross-sectional view of a detachable snap-in vehicle accessory strip prior to installation within a vehicle's accessory such as a Chevrolet Bowtie, and a cross-sectional view of a snap-in detachable vehicle accessory strip after installation within a vehicle's accessory such as a Chevrolet Bowtie respectively.

Specifically referring to FIG. 1A, a detachable snap-in strip of the present invention 20a is comprised of an elongate panel 16a, comprising a rigid polymer upper longitudinal edge 31a upon which is manufactured and attached a major rigid polymer curved upper lip 30a, a rigid polymer lower longitudinal edge 41a upon which is manufactured and attached a major rigid polymer curved lower lip 40a, a rigid polymer right side longitudinal edge 51a upon which is manufactured and attached a minor rigid polymer curved right lip 50a, and a rigid polymer left side longitudinal edge 61a upon which is manufactured and attached a minor rigid polymer curved left lip 60a.

The major rigid polymer curved upper lip 30a, the major rigid polymer curved lower lip 40a, the minor rigid polymer curved right lip 50a, and the minor rigid polymer curved left lip 60a are all manufactured and attached to their respective longitudinal edges at angles between 120 degrees and 180 degrees. The utility reasoning for the specific angle ranges, along with the rigidity and flexibility of the curved polymer lips and their respective longitudinal edges cannot be overly emphasized. Any deviation from the aforementioned specific ranges will prevent the proper installation of the detachable snap-in strip of the present invention within a vehicle's accessory such as the Chevrolet Bowtie. That is, the detachable snap-in strip will not fit and will not remain secured after installation.

Specifically referring to FIG. 1A, prior to installation of the detachable snap-in strip of the present invention, a corresponding receiving vehicle's accessory device such as a Cheverolet Bowtie 10a is pre-manufactured and is comprised of a rectangular opening 15a with a peripheral boundary portion 14a having an upper side peripheral boundary portion 36a, a lower side peripheral boundary portion 37a, a right side peripheral boundary portion 38a, and a left side longitudinal boundary portion 39a. Still referring to FIG. 1A, a detachable snap-in strip of the present invention would have at least one precut slot 25a measuring between and 0.25 to 0.5 inch manufactured within its structure for the purpose of detaching the strip when installed within a corresponding receiving vehicle's accessory device, such as a Cheverolet Bowtie. Specifically, referring to FIG. 1B is depicted a detachable snap-in strip 20a of the present invention after installation within a rectangular opening 15a of a Cheverolet Bowtie 10a.

As shown in FIG. 1C, when a detachable snap-in strip is inserted in a corresponding rectangular opening 15a of a Cheverolet Bowtie 10a, there is provided an elongate panel 16a adapted for engagement of the frontal surface area of the peripheral boundary portion 14a of the corresponding rectangular opening 15a of a Chevrolet Bowtie 10a as described in FIG. 1A, until a major rigid polymer curved upper lip 30a of the elongate panel 16a, a major rigid polymer curved lower lip 40a of the elongate panel 16a, a minor rigid polymer curved right lip 50a of the elongate panel 16a, and a minor rigid polymer curved left lip 60a of the elongate panel 16a are all simultaneously curved or contoured to precisely conform to the visible surface area of the rectangular opening 15a of the Chervolet Bowtie 10a.

During the installation process and still referring to FIG. 1C, after the major rigid polymer curved lips and the minor rigid polymer curved lips are contoured to precisely conform to the visible frontal surface area of the rectangular opening 15a of the Cheverolet Bowtie 10a, the elongate panel 16a is forcefully installed into the rectangular opening 15a by applying pressure, after which the elongate panel 16a is subsequently relaxed, and flushed with the frontal surface area of the peripheral boundary portion 14a.

Again, referring to FIG. 1C, the relaxation of the elongate panel 16a will cause said elongate panel to return to its natural rigid state allowing the major rigid polymer curved upper lip 30a to grippingly engage a corresponding rear surface area of the upper side peripheral boundary portion 36a of the Cheverolet Bowtie. The relaxation further causes the elongate panel 16a to return to its natural rigid state allowing the major rigid polymer curved lower lip 40a to grippingly engage a corresponding rear surface area of the lower side peripheral boundary portion 37a of the Cheverolet Bowtie. Next, the relaxation further causes the minor rigid polymer curved right lip 50a to grippingly engage a corresponding rear surface of the right side peripheral boundary portion 38a of the Cheverolet Bowtie. Finally, the relaxation of the elongate panel 16a further causes the minor rigid polymer curved left lip 60a to grippingly engage a corresponding rear surface area of the left side peripheral boundary portion 39a of the Cheverolet Bowtie.

The gripping engagement being displayed in FIG. 1C of the major rigid polymer curved upper and lower lips are critical in keeping the detachable vehicle accessory snap-in strip in place when installed within a vehicle's accessory. This gripping engagement is accomplished because of the polymer hook-shaped interior region that is formed with respect to the interior region of the major rigid polymer curved upper lip 30a, which protrudes continuously from and along the entirety of the rigid polymer upper longitudinal edge 31a of the elongate panel 16a at a preferred angle of between 120 degrees and 180 degrees. This gripping engagement is further accomplished because of the polymer hook-shaped interior region that is formed with respect to the interior region of the major rigid polymer curved lower lip 40a, which protrudes continuously from and along the entirety of the rigid polymer lower longitudinal edge 41a of the elongate panel 16a at a preferred angle of between 120 degrees and 180 degrees. Thus, the hook-shaped interior regions formed by the protrusions of the rigid polymer curved upper lip 30a and the rigid polymer curved lower lip 40a from the rigid polymer upper longitudinal edge 31a and the rigid polymer lower longitudinal edge 41a respectively, grippingly engage corresponding rear surface area regions of the upper side peripheral boundary portion 36a, and the lower side peripheral boundary portion 37a of a vehicle's accessory after the detachable snap-in strip of the present invention is installed therein.

Similarly, the gripping engagement being displayed in FIG. 1D of the minor rigid polymer curved right and left lips are critical in keeping the detachable snap-in strip of the present invention in place when installed within a vehicle's accessory. This critical gripping engagement function is accomplished because of the polymer hook-shaped interior region that is formed with respect to the interior region of the minor rigid polymer curved right lip 50a, which protrudes continuously from and along the entirety of the rigid polymer right side longitudinal edge 51a of the elongate panel 16a at a preferred angle of between 120 degrees and 180 degrees. This critical gripping engagement is further accomplished because of the polymer hook-shaped interior region that is formed with respect to the interior region of the minor rigid polymer curved left lip 60a, which protrudes continuously from and along the entirety of the rigid polymer left longitudinal edge 61a of the elongate panel 16a at a preferred angle of between 120 degrees and 180 degrees. Thus, the hook-shaped interior regions formed by the protrusions of the rigid polymer curved right lip 50a and the rigid polymer curved left lip 60a from the rigid polymer right longitudinal edge 51a and the rigid polymer left longitudinal edge 61a respectively, grippingly engages corresponding rear surface area regions of the right side peripheral boundary portion 38a and the left side peripheral boundary portion 39a of a vehicle's accessory after the detachable snap-in strip of the present invention is installed therein.

FIG. 1D illustrates a cross sectional view of the detachable snap-in strip of the present invention prior to installation in a vehicle's accessory such as a Cheverolet Bowtie. The minor rigid polymer curved right lip 50a and the minor rigid polymer curved left lip 60a, prior to installation, form angles preferably between 120 degrees and 180 degrees with the rigid polymer right side longitudinal edge 51a of the elongate panel 16a and the rigid polymer left side longitudinal edge 61a of the elongate panel 16a respectively. As stated above, prior to installation, the preferred angles of between 120 degrees and 180 degrees are to be maintained between the rigid polymer curved lips and the rigid polymer longitudinal edges from which the rigid polymer curved lips protrude continuously to form the necessary polymer interior region within the rigid polymer curved lips, which are used for grippingly engaging corresponding rear surface areas of the peripheral boundary portions of a vehicle's accessory when installed therein.

Still Referring to FIG. 1D, successful installation of the detachable snap-in strip of the present invention occurs when the elongate panel 16a is inserted beneath the rectangular opening 15a frontal surface area by applying pressure, and the elongate panel 16a is subsequently relaxed. FIG. 1E illustrates the cross sectional view of a successful installation of the detachable snap-in strip within a corresponding rectangular opening 15a of a vehicle's accessory such as a Chevrolet Bowtie.

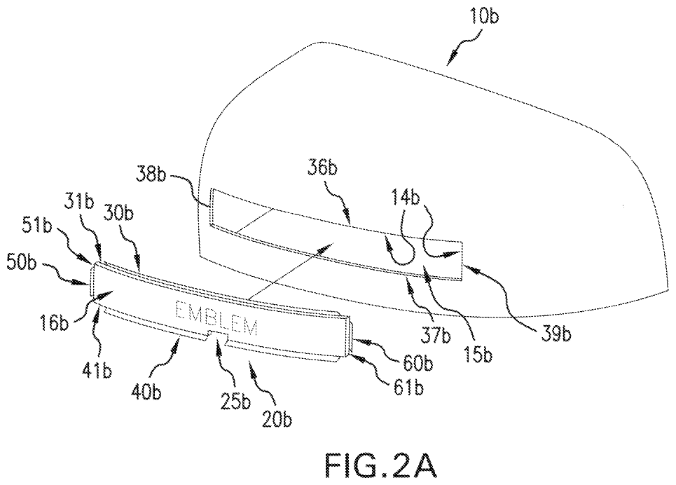

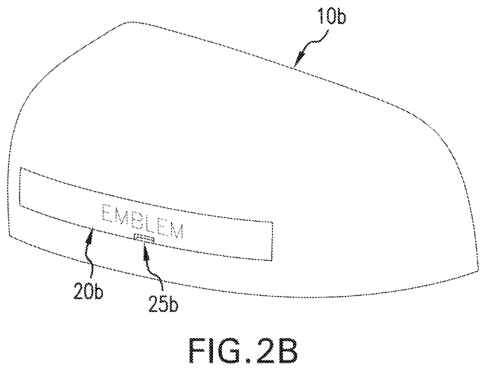

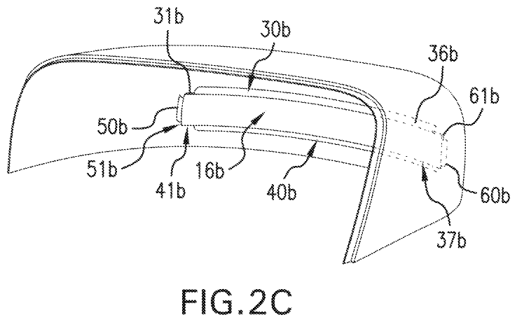

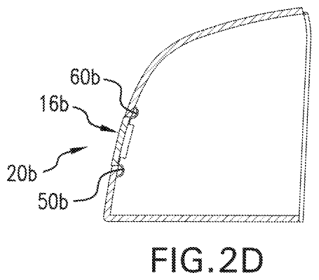

FIG. 2A is a perspective view of a detachable snap-in strip of the present invention prior to installation in an vehicle's mirror cover. FIG. 2A illustrates a vehicle mirror cover 10b comprising a rectangular opening 15b proportional in size to the elongate panel 16b of the detachable snap-in strip 20b, wherein said rectangular opening 15b is formed by a rectangular opening peripheral boundary 14b comprising an upper side longitudinal peripheral boundary portion 36b, a lower side longitudinal peripheral boundary portion 37b, a right-side longitudinal peripheral boundary portion 38b and a left-side longitudinal peripheral boundary portion 39b.

Referring to FIG. 2A and prior to installing the detachable snap-in strip 20b into a vehicle's mirror cover, the detachable snap-in strip is comprised of an elongate panel 16b comprising a rigid polymer upper longitudinal edge 31b upon which is manufactured and attached a major rigid polymer curved upper lip 30b, a rigid polymer lower longitudinal edge 41b upon which is manufactured and attached a major rigid polymer curved lower lip 40b, a rigid polymer right side longitudinal edge 51b upon which is manufactured and attached a minor rigid polymer curved right lip 50b and a rigid polymer left side longitudinal edge 61b upon which is attached a minor rigid polymer curved left lip 60b.

The major rigid polymer curved upper lip 30b, the major rigid polymer curved lower lip 40b, the minor rigid polymer curved right lip 50b, and the minor rigid polymer curved left lip 60b are all manufactured and attached to their respective rigid polymer longitudinal edges at angles between 120 degrees and 180 degrees. The utility reasoning for the specific angle ranges, along with the rigidity and flexibility of the rigid polymer curved lips and their respective rigid polymer longitudinal edges cannot be overly emphasized. Any deviation from the aforementioned specific ranges will prevent the proper installation of the detachable snap-in strip of the present invention within a vehicle's accessory such as the vehicle's side mirror cover depicted in FIG. 2A. That is, the detachable snap-in strip will not fit and will not remain secured after installation.

Still referring to FIG. 2A, a detachable snap-in strip of the present invention would have at least one 0.25 to 0.5 inch precut slot 25b manufactured within its structure for the purpose of detaching the strip when installed within a corresponding receiving vehicle's accessory device, such as a vehicle side mirror cover. FIG. 2B depicts a frontal perspective view of the detachable snap-in strip 20b of the present invention after installation within a rectangular opening 15b of a vehicle's side mirror cover.

Still referring to the vehicle side mirror cover and as shown in FIG. 2C, when a detachable snap-in strip is inserted in a corresponding rectangular opening 15b of a vehicle's side mirror cover 20b, there is provided the elongate panel 16b adapted for engagement of the peripheral boundary portion 14b of a frontal surface of the corresponding rectangular opening 15b of a vehicle's side mirror cover as described in FIG. 2A, until the major rigid polymer curved upper lip 30b of the elongate panel 16b, the major rigid polymer curved lower lip 40b of the elongate panel 16b, the minor rigid polymer curved right lip 50b of the elongate panel 16b, and the minor rigid polymer curved left lip 60b of the elongate panel 16b are all simultaneously curved or contoured to precisely conform to the visible surface area of the rectangular opening 15b of a vehicle's side mirror cover 20b.

During the installation process and still referring to FIG. 2C, after the major rigid polymer curved upper lip and lower lip, and the minor rigid polymer curved right lip and left lip are contoured to precisely conform to the visible frontal surface area of the rectangular opening 15b of a vehicle's mirror cover, the elongate panel 16b is forcefully installed into the rectangular opening 15b by applying pressure, after which the elongate panel 16b is subsequently relaxed, and flushed with the frontal surface area of the peripheral boundary portion 14b.

The relaxation of the elongate panel 16b will cause said elongate panel to return to its natural rigid state allowing the major rigid polymer curved upper lip 30b to grippingly engage a corresponding rear surface area of an upper side peripheral boundary portion 36b of the vehicle's side mirror cover. The relaxation further causes the elongate panel 16b to return to its natural rigid state allowing the major rigid polymer curved lower lip 40b to grippingly engage a corresponding rear surface area of the lower side peripheral boundary portion 37b of the vehicle's side mirror cover. Next, the relaxation further causes the minor rigid polymer curved right lip 50b to grippingly engage a corresponding rear surface area of the right side peripheral boundary portion 38b of the vehicle's side mirror cover. Finally, the relaxation of the elongate panel 16b further causes the minor longitudinal curved left lip 60b to grippingly engage a corresponding rear surface area of the left side peripheral boundary portion 39b of the vehicle's side mirror cover.

The gripping engagement of the major rigid polymer curved upper lip and lower lip are critical in keeping the detachable vehicle accessory snap-in strip in place when installed within a vehicle's accessory. This gripping engagement is accomplished because of the polymer hook-shaped interior region that is formed with respect to the interior region of the major rigid polymer curved upper lip 30b, which protrudes continuously from and along the entirety of the rigid polymer upper longitudinal edge 31b of the elongate panel 16b at a preferred angle of between 120 degrees and 180 degrees. This gripping engagement is further accomplished because of the polymer hook-shaped interior region that is formed with respect to the interior region of the major rigid polymer curved lower lip 40b, which protrudes continuously from and along the entirety of the rigid polymer lower longitudinal edge 41b of the elongate panel 16b at a preferred angle of between 120 degrees and 180 degrees. Thus, the hook-shaped interior regions formed by the protrusions of the rigid polymer curved upper lip 30b and the rigid polymer curved lower lip 40b from the rigid polymer upper longitudinal edge 31b and the rigid polymer lower longitudinal edge 41b respectively, grippingly engage corresponding rear surface area regions of the side mirror cover accessory after said detachable snap-in strip of the present invention is installed therein.

Similarly, the gripping engagement of the minor rigid polymer curved right and left lips are critical in keeping the detachable snap-in strip of the present invention in place when installed within a vehicle's accessory. This critical gripping engagement function is accomplished because the polymer hook-shaped interior region that is formed with respect to the minor rigid polymer curved right lip 50b protrudes continuously from and along the entirety of the rigid polymer right side longitudinal edge 51b of the elongate panel at a preferred angle of between 120 degrees and 180 degrees. This critical gripping engagement function is further accomplished because of the polymer hook-shaped interior region that is formed regarding the minor rigid polymer curved left lip 60b, which protrudes continuously from and along the entirety of the rigid polymer left longitudinal edge 61b of the elongate panel at a preferred angle of between 120 degrees and 180 degrees. That therefore, the hook-shaped interior regions formed by the protrusions of the rigid polymer curved right lip and the rigid polymer curved left lip from the rigid polymer right side longitudinal edge and the rigid polymer left side longitudinal edge respectively, grippingly engage corresponding rear surface area regions of the vehicle's side mirror cover accessory after said detachable snap-in strip of the present invention is installed therein.

FIG. 2D of the present invention illustrates a cross sectional view of the detachable snap-in strip of the present invention after installation in a vehicle's accessory such as a vehicle's side mirror cover. Although not shown in FIG. 2D, but shown in FIG. 2A, the minor rigid polymer curved right lip 50b and the minor rigid polymer curved left lip 60b, prior to installation, form angles preferably between 120 degrees and 180 degrees with the rigid polymer right side longitudinal edge 51b of the elongate plate 16b and the rigid polymer left side longitudinal edge 61b of the elongate plate 16b respectively. Referring to FIG. 2D through the lenses of FIG. 2A and FIG. 2C, the preferred angles of between 120 degrees and 180 degrees are to be maintained between the rigid polymer curved lips and the rigid polymer longitudinal edges from which the curved lips protrude continuously to form the necessary polymer interior regions within the curved lips for grippingly engaging corresponding rear surface areas respectively of the vehicle's side mirror cover accessory. Finally, as illustrated in FIG. 2D successful installation of the detachable snap-in strip of the present invention occurs when the elongate panel 16b is installed within the rectangular opening 15 frontal surface area by applying pressure, and the elongate panel 16b is subsequently relaxed, and flushed with the frontal surface area of the peripheral boundary portion 14b.

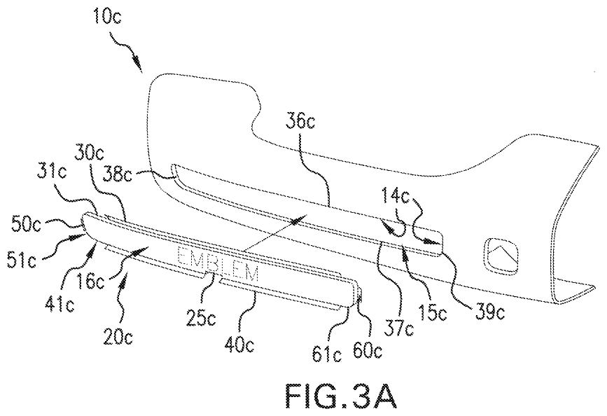

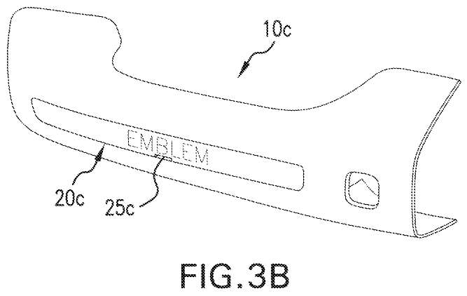

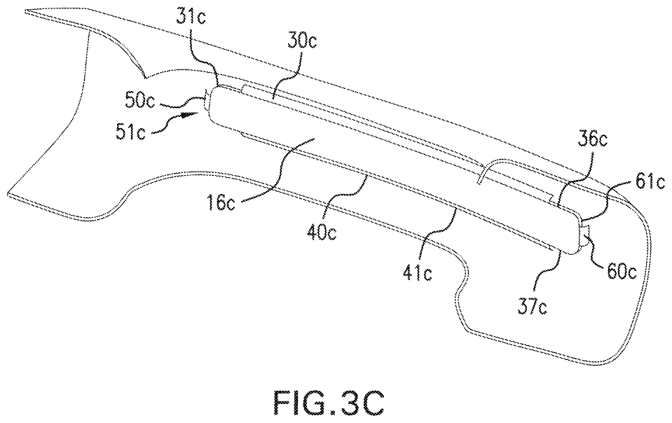

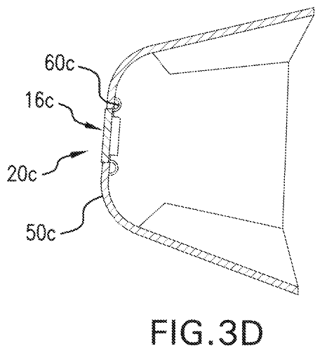

FIG. 3A is a perspective view of a detachable snap-in strip of the present invention prior to installation in an vehicle's mirror cover. FIG. 3A illustrates a snap-on vehicle door handle 10c comprising a rectangular opening 15c corresponding in side to an elongate panel 16c of the detachable snap-in strip 20c, wherein said rectangular opening 15c is formed by a rectangular opening peripheral boundary 14c comprising an upper side longitudinal peripheral boundary portion 36c, a lower side longitudinal peripheral boundary portion 37c, a right-side longitudinal peripheral boundary portion 38c and a left-side longitudinal peripheral boundary portion 39c.

Yet still, referring to FIG. 3A, and prior to installing the detachable snap-in strip assembly 20c into the snap-on door handle, the detachable snap-in strip assembly is comprised on a elongate panel 16c comprising a rigid polymer upper longitudinal edge 31c upon which is manufactured and attached a major rigid polymer curved upper lip 30c, a rigid polymer lower longitudinal edge 41c upon which is manufactured and attached a major rigid polymer curved lower lip 40c, a rigid polymer right side longitudinal edge 51c upon which is manufactured and attached a minor rigid polymer curved right lip 50c, and a rigid polymer left side longitudinal edge 61c upon which is manufactured and attached a minor rigid polymer curved left lip 60c.

The major rigid polymer longitudinal curved upper lip 30c, the major rigid polymer longitudinal curved lower lip 40c, the minor rigid polymer longitudinal curved right lip 50c, and the minor rigid polymer longitudinal curved left lip 60c are all manufactured and attached to their respective curved longitudinal edges at angles between 120 degrees and 180 degrees. The utility reasoning for the specific angle ranges, along with the rigidity and flexibility of the curved rigid polymer lips and their respective rigid polymer longitudinal edges cannot be overly emphasized. Any deviation from the aforementioned specific ranges will prevent the proper installation of the detachable snap-in strip of the present invention within a vehicle's accessory such as the snap-on door handle depicted in FIG. 3A. That is, the detachable snap-in strip will not fit and will not remain secured after installation.

Still referring to FIG. 3A, a detachable snap-in strip of the present invention would have at least one 0.25 to 0.5 inch precut slot 25c manufactured within its structure for the purpose of detaching the strip when installed within a corresponding receiving vehicle's accessory device, such as the snap-on door handle. FIG. 3B depicts a frontal perspective view of the detachable snap-in strip 20c of the present invention after installation within a rectangular opening 15c of the vehicle's snap-on door handle.

Still referring to the vehicle side mirror cover and as shown in FIG. 3C, when a detachable snap-in strip is inserted in a corresponding rectangular opening 15c of a vehicle's snap-on door handle cover 20c, there is provided an elongate panel 16c adapted for engagement of a peripheral boundary portion 14c of a frontal surface of a corresponding rectangular opening 15c of a vehicle's snap-on door handle as described in FIG. 3A, until the major rigid polymer curved upper lip 30c of the elongate panel 16c, the major rigid polymer longitudinal curved lower lip 40c of the elongate panel 16c, the minor rigid polymer curved right lip 50c of the elongate panel 16c, and the minor rigid polymer longitudinal curved left lip 60c of an elongate panel 16c are all simultaneously curved or contoured to precisely conform to the visible surface area of the rectangular opening 15c of a vehicle's snap-on door handle cover 20c.

During the installation process and still referring to FIG. 3C, after the major rigid polymer curved upper lip and lower lip, and the minor rigid polymer curved right lip and left lip are contoured to precisely conform to the visible frontal surface area of the rectangular opening 15c of a vehicle's snap-on door handle cover, the elongate panel 16c is forcefully installed into the rectangular opening 15c by applying pressure, after which the elongate panel 16c is subsequently relaxed, and flushed with the frontal surface area of the peripheral boundary portion 14c.

The relaxation of the elongate panel 16c will cause said elongate panel 16c to return to its natural rigid state allowing the major longitudinal curved upper lip 30c to grippingly engage a corresponding rear surface area of an upper side peripheral boundary portion 36c of the vehicle's snap-on door handle. The relaxation further causes the elongate panel 16c to return to its natural rigid state allowing the major rigid polymer curved lower lip 40c to grippingly engage a corresponding rear surface area of the lower side peripheral boundary portion 37c of the vehicle's snap-on door handle cover. Next, the relaxation further causes the minor rigid polymer curved right lip 50c to grippingly engage a corresponding rear surface of the right side peripheral boundary portion 38c of the vehicle's snap-on door handle cover. Finally, the relaxation of the elongate panel 16c further causes the minor rigid polymer curved left lip 60c to grippingly engage a corresponding rear surface area of the left side peripheral boundary portion 39c as shown in FIG. 3A of the vehicle's snap-on door handle cover.

The gripping engagement of the major rigid polymer curved upper and lower lips is critical in keeping the detachable vehicle accessory snap-in strip in place when installed within a vehicle's accessory. This gripping engagement is accomplished because of the polymer hook-shaped interior region that is formed with respect to the interior of the major rigid polymer curved upper lip 30c, which protrudes continuously from and along the entirety of the rigid polymer upper longitudinal edge 31c of the elongate panel 16c at a preferred angle of between 120 degrees and 180 degrees. This gripping engagement is further accomplished because of the polymer hook-shaped interior region regarding the interior region of the major rigid polymer curved lower lip 40c, which protrudes continuously from and along the entirety of the rigid polymer lower longitudinal edge 41c of the elongate panel at a preferred angle of between 120 degrees and 180 degrees. Thus, the hook-shaped interior regions formed by the protrusions of the rigid polymer curved upper lip 30c and rigid polymer curved lower lip 40c from the rigid polymer upper longitudinal edge 31c and the rigid polymer lower longitudinal edge 41c respectively, grippingly engage corresponding rear surface area regions of the side mirror cover accessory after said detachable snap-in strip of the present invention is installed therein.

Similarly, the gripping engagement of the minor rigid polymer curved right lip and the minor rigid polymer curved left lip are critical in keeping the detachable snap-in strip of the present invention in place when installed within a vehicle's accessory. This critical gripping engagement function is accomplished because the polymer hook-shaped interior region that is formed with respect to the minor rigid polymer curved right lip 50c protrudes continuously from and along the entirety of the rigid polymer right side longitudinal edge 51c of the elongate panel 16c at a preferred angle of between 120 degrees and 180 degrees. This critical gripping engagement function is further accomplished because of the polymer hook-shaped interior region that is formed with respect to the minor rigid polymer curved left lip 60c, which protrudes continuously from and along the entirety of the rigid polymer left longitudinal edge 61c of the elongate panel 16c at a preferred angle of between 120 degrees and 180 degrees. That therefore, the hook-shaped interior regions formed by the protrusions of the rigid polymer curved right lip 50c and the rigid polymer curved left lip 60c from the rigid polymer right longitudinal edge 51c and the rigid polymer left longitudinal edge 61c respectively, grippingly engage corresponding rear surface area regions of the vehicle's door handle cover accessory after said detachable snap-in strip of the present invention is installed therein.

Still yet, referring to FIG. 3D of the present invention illustrates a cross sectional view of the detachable snap-in strip of the present invention after installation in a vehicle's accessory such as a vehicle's snap-on door handle. Although not shown in FIG. 3D, but shown in FIG. 3A, the minor rigid polymer curved right lip 50c and the minor rigid polymer curved left lip 60c, prior to installation, form angles preferably between 120 degrees and 180 degrees with the rigid polymer right side longitudinal edge 51c of the elongate plate 16c and the rigid polymer left side longitudinal edge 61c of the elongate plate 16c respectively. A closer look at FIG. 3D through the lenses of FIG. 3A and FIG. 3C, the preferred angles of between 120 degrees and 180 degrees are to be maintained between the rigid polymer curved lips and the rigid polymer longitudinal edges from which the curved lips protrude continuously to form the necessary polymer interior region within the curved lips for grippingly engaging corresponding rear surface areas of the vehicle's snap-on door cover accessory when installed therein. Finally, as illustrated in FIG. 3D successful installation of the detachable snap-in strip of the present invention occurs when the elongate panel 16c is forcefully installed into the rectangular opening 15c frontal surface area by applying pressure, after which the elongate panel 16c is subsequently relaxed and flushed with the frontal surface area of the peripheral boundary portion 14c.

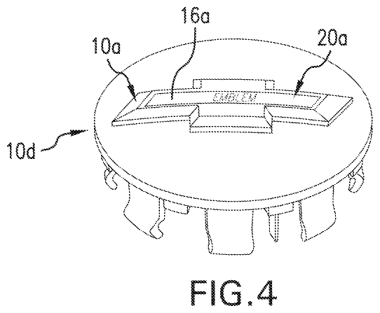

Yet still, FIG. 4 illustrates is a wheel cover cap accessory 10d with a Cheverolet Bowtie 10a accessory attached thereto containing an installed snap-in detachable strip 20a of the present invention. Successful installation of the detachable snap-in strip of the present invention occurs when the elongate panel 16a is forcefully installed into the rectangular opening 15a frontal surface area by applying pressure, and the elongate panel 16a is subsequently relaxed and flushed with the frontal surface area of the peripheral boundary portion 14a, as described in FIG. 1A through FIG. 1E of the accompanied drawings. As stated above, prior to installation, the preferred angles of between 120 degrees and 180 degrees are to be maintained between the rigid polymer curved lips and the rigid polymer longitudinal edges from which the rigid polymer curved lips protrude continuously to form the necessary polymer interior regions within the rigid polymer curved lips for grippingly engaging corresponding rear surface areas of the vehicle's wheel cover cap accessory when installed therein.

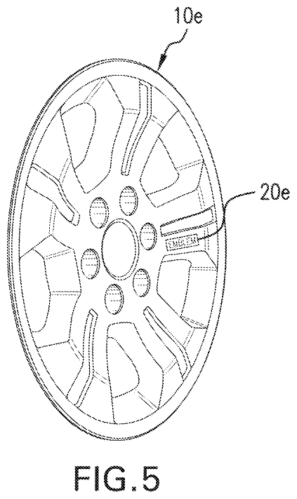

Yet, FIG. 5 illustrates a wheel cover overlay accessory 10e containing an installed snap-in detachable strip 20e of the present invention. Successful installation of the detachable snap-in strip of the present invention occurs when the elongate panel 16e, not shown, is forcefully installed into the rectangular opening 15e frontal surface area, also not shown, by applying pressure, and the elongate panel 16e is subsequently relaxed. As stated above, prior to installation, the preferred angles of between 120 degrees and 180 degrees are to be maintained between the rigid polymer curved lips, not shown, and the rigid polymer longitudinal edges, not shown, from which the rigid polymer curved lips protrude continuously to form the necessary polymer interior region within the curved lips for grippingly engaging corresponding rear surface areas, not shown, of the vehicle's snap-on wheel cover overlay accessory when installed therein.

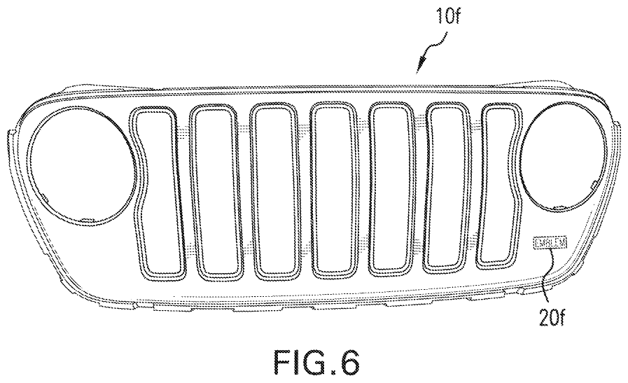

Finally, FIG. 6 illustrates is a snap-on grille overlay accessory 10f containing an installed snap-in detachable strip 20f of the present invention. Successful installation of the detachable snap-in strip of the present invention occurs when the elongate panel 16f, not shown, is forcefully installed into the rectangular opening 15f frontal surface area, also not shown, by applying pressure, and the elongate panel 16f by applying pressure, after which the elongate panel 16f is subsequently relaxed, and flushed with the frontal surface area of the peripheral boundary portion not shown. As stated above, prior to installation, the preferred angles of between 120 degrees and 180 degrees are to be maintained between the rigid polymer curved lips, not shown, and the rigid polymer longitudinal edges, not shown, from which the rigid polymer curved lips protrude continuously to form the necessary polymer interior region within the rigid polymer curved lips for grippingly engaging corresponding rear surface are, not shown, of the vehicle's snap-on grille overlay accessory when installed therein.

That to produce the finished embodiments described in the specification, suitable polymer materials well known in the art are first selected and tested for strength, durability, malleability and resistance, etc. to meet after-market standards and particularly to meet the rigid original equipment manufacturer (OEM) standards demanded by established automobile manufacturers and distributors. Suitable rigid polymer materials are used straightly and without mixing or proportionally in percentile combination with other polymer materials, including but not limited to, polypropylene, polystyrene, polyethylene, polyvinyl chloride, and acrylonitrile butadeine styrene. Although rigid polymer materials are preferred, other possible non-polymer materials envisioned by the inventor are wood, metal, fiberglass, stainless steel, and carbon fabric, etc.

First, these materials (prior to being chrome plated and after being chrome plated) are placed through thermal cycle test(s) and exposed to predetermined temperature to examine for dimensional changes, deformation, clearance gaps, waviness, unevenness, creases, split, crack, breakage, blister, peeling and discoloration, etc. Second, these materials (prior to being chrome plated and after being chrome plated) are placed through chemical resistance test(s) and exposed to predetermined chemical concentrations, such as artificial perspiration, detergent, insect repellent, sun tan oil, sun screening cream, and liquid paraffin, etc. to examine for dissolving, cloudiness, stains, discoloration, deformation, uneven surfaces, blooming, sticky surfaces, contamination, glossiness, cracking, breakage, softening, hardening, swelling, thinning, and shrinkage, etc. Third, these materials (prior to being chrome plated and after being chrome plated) are placed under falling ball impact test(s) by dropping a steel ball from a predetermined height to examine for cracks, breakage, detrimental deformation on the material's visible surface, and for conforming, etc. Fourth, these materials (prior to being chrome plated and after being chrome plated) are placed through pencil scratch test(s) and exposed to predetermined variable models of pencils, so as to examine for surface hardness and scratch resistance, etc. Fifth, these materials (prior to being chrome plated and after being chrome plated) are placed through abrasion resistance test(s) or TABER and exposed to predetermined abrasion wheels, load and rotation speed, etc. so as to examine for glossiness before gloss, after gloss and overall gloss retention. Sixth, these materials (prior to being chrome plated and after being chrome plated) are placed through scratch resistance test(s) and exposed to predetermined load, scratching speed and scratch length using sand paper, glass bead and abrasion tester to examine for based surface exposure, flaw observation rank, and the difference between gloss value after test and initial gloss value.

After the suitable materials are selected and tested as described above, a three-dimensional (3D) scanned imaging of the individual embodiment component parts is generated. Next, the three-dimensional scanned imaging of said individual embodiment component parts is transferred to an injection molding computer to generate the injection molding designed precisely corresponding to each individual component parts of the three embodiments of the present invention. Next, the desired material (preferably, but not limited to, rigid polymer material) is placed in the injection molding to form the individual component parts. After the individual component parts are formed from the injection molding, a fine tuning/finishing process ensues where the component parts are smoothed to remove all/any sharp and/or rough edges. Finally, the individual component parts of the present invention are chromed to obtain the final product.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter. The snap-on technology of this present invention with variation and unique contours can be used for other car accessories such as wheels, rear view mirrors, side mirrors, license plate covers, etc. These detachable vehicle accessory snap-in strip are capable of being fitted with LEDs as deemed necessary and appropriate and consistent with various regulations.

Those skilled in the art will readily appreciate that various modifications and changes can be applied to the embodiment of the invention as herein before described without departing from its scope, defined in and by the appended claims.

1. A detachable snap-in strip constructed of polymer material and capable of bearing an emblem while affixed within a vehicle's accessory comprising: an elongate panel comprised of a rigid polymer upper longitudinal edge upon which is attached a major rigid polymer curved upper lip, a rigid polymer lower longitudinal edge upon which is attached a major rigid polymer curved lower lip, a rigid polymer right side longitudinal edge upon which is attached a minor rigid polymer curved right lip, and a rigid polymer left side longitudinal edge upon which is attached a minor rigid polymer curved left lip.

2. The detachable snap-in strip as in claim 1, wherein the major rigid polymer curved upper lip is attached to the major rigid polymer upper longitudinal edge at angles between 120 degrees and 180 degrees.

3. The detachable snap-in strip as in claim 2, wherein the major rigid polymer curved lower lip is attached to the major rigid polymer lower longitudinal edge at angles between 120 degrees and 180 degrees.

4. The detachable snap-in strip as in claim 3, wherein the major rigid polymer curved right lip is attached to the major rigid polymer right side longitudinal edge at angles between 120 degrees and 180 degrees.

5. The detachable snap-in strip as in claim 4, wherein the major rigid polymer curved left lip is attached to the major rigid polymer left side longitudinal edge at angles between 120 degrees and 180 degrees.

6. The detachable snap-in strip as in claim 5, wherein there is at least one precut slot measuring between 0.25 and 0.5 inches manufactured within said detachable snap-in strip for easy removal of said snap-in strip after installation within a vehicle's accessory device.

7. The detachable snap-in strip as in claim 6, wherein the elongate panel engages a frontal surface area of a peripheral boundary portion of a corresponding rectangular opening until said major rigid polymer curved upper lip, said major rigid polymer curved lower lip, said minor rigid polymer curved right lip, and said minor rigid polymer curved left lip are contoured to precisely conform to the frontal surface area of the peripheral boundary portion of the rectangular opening.

8. The detachable snap-in strip as in claim 7, wherein the elongate panel is forcefully installed into the rectangular opening by applying pressure, after which the elongate panel is subsequently relaxed, and flushed with the frontal surface area of the peripheral boundary portion.

9. The detachable snap-in strip as in claim 8, wherein the major rigid polymer curved upper lip grippingly engages a corresponding rear surface area of an upper side peripheral boundary portion.

10. The detachable snap-in strip as in claim 9, wherein the major rigid polymer curved lower lip grippingly engages a corresponding rear surface area of a lower side peripheral boundary portion.

11. The detachable snap-in strip as in claim 10, wherein the minor rigid polymer curved right lip grippingly engages a corresponding rear surface area of a right side peripheral boundary portion.

12. The detachable snap-in strip as in claim 11, wherein the minor rigid polymer curved left lip grippingly engages a corresponding rear surface area of a left side peripheral boundary portion.

13. A detachable snap-in strip constructed of polymer material and capable of bearing an emblem while affixed within a vehicle's accessory comprising: an elongate panel comprised of a rigid polymer upper longitudinal edge upon which is attached a major rigid polymer curved upper lip, a rigid polymer lower longitudinal edge upon which is attached a major rigid polymer curved lower lip, a rigid polymer right side longitudinal edge upon which is attached a minor rigid polymer curved right lip, and a rigid polymer left side longitudinal edge upon which is attached a minor rigid polymer curved left lip;
and wherein said major rigid polymer curved upper lip protrudes continuously from along the entirety of said rigid polymer upper longitudinal edge to form a polymer hook-shaped interior region which grippingly engages a corresponding rear surface area of an upper longitudinal peripheral boundary portion;
said major rigid polymer curved lower lip protrudes continuously from along the entirety of said rigid polymer lower longitudinal edge to form a polymer hook-shaped interior region which grippingly engages a corresponding rear surface area of a lower longitudinal peripheral boundary portion;
said major rigid polymer curved right lip protrudes continuously from along the entirety of said rigid polymer right side longitudinal edge to form a polymer hook-shaped interior region which grippingly engages a corresponding rear surface area of a right side longitudinal peripheral boundary portion; and
said major rigid polymer curved left lip protrudes continuously from along the entirety of said rigid polymer left side longitudinal edge to form a polymer hook-shaped interior region which grippingly engages a corresponding rear surface area of a left side longitudinal peripheral boundary portion;

14. The detachable snap-in strip as in claim 13, wherein the major rigid polymer curved upper lip is attached to the major rigid polymer upper longitudinal edge at angles between 120 degrees and 180 degrees.

15. The detachable snap-in strip as in claim 14, wherein the major rigid polymer curved lower lip is attached to the major rigid polymer lower longitudinal edge at angles between 120 degrees and 180 degrees.

16. The detachable snap-in strip as in claim 15, wherein the major rigid polymer curved right lip is attached to the major rigid polymer right side longitudinal edge at angles between 120 degrees and 180 degrees.

17. The detachable snap-in strip as in claim 16, wherein the major rigid polymer curved left lip is attached to the major rigid polymer left side longitudinal edge at angles between 120 degrees and 180 degrees.

18. The detachable snap-in strip as in claim 17, wherein there is at least one precut slot measuring between 0.25 and 0.5 inches manufactured within said detachable snap-in strip for easy removal of said snap-in strip after installation within a vehicle's accessory device.

19. The detachable snap-in strip as in claim 18, wherein the elongate panel engages a frontal surface area of a peripheral boundary portion of a corresponding rectangular opening until said major rigid polymer curved upper lip, said major rigid polymer curved lower lip, said minor rigid polymer curved right lip, and said minor rigid polymer curved left lip are contoured to precisely conform to the frontal surface area of the peripheral boundary portion of the rectangular opening.

20. The detachable snap-in strip as in claim 19, wherein the elongate panel is forcefully installed into the rectangular opening by applying pressure, after which the elongate panel is subsequently relaxed, and flushed with the frontal surface area of the peripheral boundary portion.

21. The detachable snap-in strip as in claim 20, wherein the major rigid polymer curved upper lip grippingly engages a corresponding rear surface area of an upper side peripheral boundary portion.

22. The detachable snap-in strip as in claim 9, wherein the major rigid polymer curved lower lip grippingly engages a corresponding rear surface area of a lower side peripheral boundary portion.

23. The detachable snap-in strip as in claim 10, wherein the minor rigid polymer curved right lip grippingly engages a corresponding rear surface area of a right side peripheral boundary portion.

24. The detachable snap-in strip as in claim 11, wherein the minor rigid polymer curved left lip grippingly engages a corresponding rear surface area of a left side peripheral boundary portion.

25. A detachable snap-in strip constructed of polymer material and capable of bearing an emblem while affixed within a vehicle's accessory comprising: an elongate panel comprised of a rigid polymer upper longitudinal edge upon which is attached a major rigid polymer curved upper lip, a rigid polymer lower longitudinal edge upon which is attached a major rigid polymer curved lower lip, a rigid polymer right side longitudinal edge upon which is attached a minor rigid polymer curved right lip, and a rigid polymer left side longitudinal edge upon which is attached a minor rigid polymer curved left lip;
and wherein said major rigid polymer curved upper lip protrudes continuously from along the entirety of said rigid polymer upper longitudinal edge to form a polymer hook-shaped interior region which grippingly engages a corresponding rear surface area of an upper longitudinal peripheral boundary portion;
said major rigid polymer curved lower lip protrudes continuously from along the entirety of said rigid polymer lower longitudinal edge to form a polymer hook-shaped interior region which grippingly engages a corresponding rear surface area of a lower longitudinal peripheral boundary portion;
said major rigid polymer curved right lip protrudes continuously from along the entirety of said rigid polymer right side longitudinal edge to form a polymer hook-shaped interior region which grippingly engages a corresponding rear surface area of a right side longitudinal peripheral boundary portion;
said major rigid polymer curved left lip protrudes continuously from along the entirety of said rigid polymer left side longitudinal edge to form a polymer hook-shaped interior region which grippingly engages a corresponding rear surface area of a left side longitudinal peripheral boundary portion;
and said detachable snap-in strip is manufactured by process comprising the steps of:
i. selecting suitable polymer materials;
ii. performing thermal cycle testing of said suitable polymer materials;
iii. performing chemical resisting testing of said suitable polymer materials;
iv. performing falling ball impact testing of said suitable polymer materials;
v. performing pencil scratching testing of said suitable polymer materials;
vi. performing abrasion resistance testing of said suitable polymer materials;
vii. performing scratch resistance testing of said suitable polymer materials;
viii. providing a three dimensional scanned imaging of individual component parts;
ix. transferring said three dimensional scanned imaging of said individual component parts to an injection molding computer to generate precise corresponding design of said component parts;
x. placing rigid polymer material in an injection molding to form said individual component parts;
xi. finishing said component parts by smoothing said parts and removing all sharp and rough edges; and
xii. chroming said component parts.
